(19) United States
(12) Patent Application Publication
(10) Pub. No.: US 2014/0196898 A1
(43) Pub. Date: Jul. 17, 2014

(54) Proppant

(71) Applicant: BASF SE, Ludwigshafen (DE)

(72) Inventors: Christopher Tanguay, Trenton, MI (US); Rajesh Kumar, Riverview, MI (US); Fikri Emrah Alemdaroglu, Erenkoy Istanbul (TR)

(21) Appl. No.: 14/115,391

(22) PCT Filed: Apr. 25, 2012
(86) PCT No.: PCT/US2012/034999

§ 371 Date: Feb. 18, 2014

Related U.S. Application Data
(60) Provisional application No. 61/482,890, filed on May 5, 2011.

(51) Int. Cl. C09K 8/80; E21B 43/267

(52) U.S. Cl. CPC C09K 8/805; E21B 43/267
USPC 166/280.2; 507/244; 507/204; 427/212

(57) ABSTRACT

A proppant includes a particle and a hybrid coating disposed about the particle. The particle is present in an amount of from about 90 to about 99.5 percent by weight based on the total weight of the proppant and the hybrid coating is present in an amount of from about 0.5 to about 10 percent by weight based on the total weight of the proppant. The hybrid coating comprises the reaction product of an isocyanate component and an alkali metal silicate solution including water and an alkali metal silicate. A method of forming the proppant includes the steps of providing the particle, the isocyanate composition, and the alkali metal silicate solution. The method also includes the steps of combining the isocyanate composition and the alkali metal silicate solution to react and form the hybrid coating and coating the particle with the hybrid coating to form the proppant.

### CROSS REFERENCE TO RELATED APPLICATIONS

This application claims the benefit of U.S. Provisional Patent Application Ser. No. 61/482,890 filed on May 5, 2011 which is incorporated herewith in its entirety.

### FIELD OF THE INVENTION

The subject invention generally relates to a proppant and a method of forming the proppant. More specifically, the subject invention relates to a proppant which comprises a particle and a coating disposed on the particle, and which is used during hydraulic fracturing of a subterranean formation.

### DESCRIPTION OF THE RELATED ART

Domestic energy needs in the United States currently outpace readily accessible energy resources, which has forced an increasing dependence on foreign petroleum fuels, such as oil and gas. At the same time, existing United States energy resources are significantly underutilized, in part due to inefficient oil and gas procurement methods and a deterioration in the quality of raw materials such as unrefined petroleum fuels.

Petroleum fuels are typically procured from subsurface reservoirs via a wellbore. Petroleum fuels are currently procured from low-permeability reservoirs through hydraulic fracturing of subterranean formations, such as bodies of rock having varying degrees of porosity and permeability. Hydraulic fracturing enhances production by creating fractures that emanate from the subsurface reservoir or wellbore, and provides increased flow channels for petroleum fuels. During hydraulic fracturing, specially-engineered carrier fluids are pumped at high pressure and velocity into the subsurface reservoir to cause fractures in the subterranean formations. A propping agent, i.e., a proppant, is mixed with the carrier fluids to keep the fractures open when hydraulic fracturing is complete. The proppant typically comprises a particle and a coating disposed on the particle. The proppant remains in place in the fractures once the high pressure is removed, and thereby props open the fractures to enhance petroleum fuel flow into the wellbore. Consequently, the proppant increases procurement of petroleum fuel by creating a high-permeability, supported channel through which the petroleum fuel can flow.

However, many existing proppants exhibit inadequate thermal stability for high temperature and pressure applications, e.g. wellbores and subsurface reservoirs having temperatures greater than 70° F. and pressures, i.e., closure stresses, greater than 7,500 psi. As an example of a high temperature application, certain wellbores and subsurface reservoirs throughout the world have temperatures of about 375° F. and 540° F. As an example of a high pressure application, certain wellbores and subsurface reservoirs throughout the world have closure stresses that exceed 12,000 or even 14,000 psi. As such, many existing proppants, which comprise coatings, have coatings such as epoxy or phenolic coatings, which melt, degrade, and/or shear off the particle in an uncontrolled manner when exposed to such high temperatures and pressures. Also, many existing proppants do not include active agents, such as microorganisms and catalysts, to improve the quality of the petroleum fuel recovered from the subsurface reservoir.

Further, many existing proppants comprise coatings having inadequate crush resistance. That is, many existing proppants comprise non-uniform coatings that include defects, such as gaps or indentations, which contribute to premature breakdown and/or failure of the coating. Since the coating typically provides a cushioning effect for the proppant and evenly distributes high pressures around the proppant, premature breakdown and/or failure of the coating undermines the crush resistance of the proppant. Crushed proppants cannot effectively prop open fractures and often contribute to impurities in unrefined petroleum fuels in the form of dust particles.

Moreover, many existing proppants also exhibit unpredictable consolidation patterns and suffer from inadequate permeability in wellbores, i.e., the extent to which the proppant allows the flow of petroleum fuels. That is, many existing proppants have a lower permeability and impede petroleum fuel flow. Further, many existing proppants consolidate into aggregated, near-solid, non-permeable proppant packs and prevent adequate flow and procurement of petroleum fuels from subsurface reservoirs.

Also, many existing proppants are not compatible with low-viscosity carrier fluids having viscosities of less than about 3,000 cps at 80° C. Low-viscosity carrier fluids are typically pumped into wellbores at higher pressures than high-viscosity carrier fluids to ensure proper fracturing of the subterranean formation. Consequently, many existing coatings fail mechanically, i.e., shear off the particle, when exposed to high pressures or react chemically with low-viscosity carrier fluids and degrade.

Finally, many existing proppants are coated via noneconomical coating processes and therefore contribute to increased production costs. That is, many existing proppants require multiple layers of coatings, which results in time-consuming and expensive coating processes.

Due to the inadequacies of existing proppants, there remains an opportunity to provide an improved proppant.

### SUMMARY OF THE INVENTION AND ADVANTAGES

The subject invention provides a proppant for hydraulically fracturing a subterranean formation. The proppant includes a particle and a hybrid coating disposed about the particle. The particle is present in an amount of from about 90 to about 99.5 percent by weight based on the total weight of the proppant and the hybrid coating is present in an amount of from about 0.5 to about 10 percent by weight based on the total weight of the particle. The hybrid coating comprises the reaction product of an isocyanate component and an alkali metal silicate solution including water and an alkali metal silicate.

A method of forming the proppant includes the steps of providing the particle, the isocyanate composition, and the alkali metal silicate solution. The method also includes the steps of combining the isocyanate composition and the alkali metal silicate solution to react and form the hybrid coating and coating the particle with the hybrid coating to form the proppant.

Advantageously, the proppant of the subject invention improves upon the performance of existing proppants. The performance of the proppant is attributable to the hybrid coating which provides the benefits, such as hardness, of inorganic polymers, e.g. silica gels, as well as the benefits, such as durability, of organic polymers, e.g. polyureas. Further, the hybrid coating does not have to be applied to the particle in substantial amounts to form the proppant which has excellent performance properties. Moreover, the proppant can be formed efficiently and in various locations, e.g. in the factory, in the field, etc., because the isocyanate composition and the alkali metal silicate solution typically react at ambient temperatures (e.g. 20° C.) to form the hybrid coating.

### DETAILED DESCRIPTION OF THE INVENTION

The subject invention includes a proppant, a method of forming, or preparing, the proppant, a method of hydraulically fracturing a subterranean formation, and a method of filtering a fluid. The proppant is typically used, in conjunction with a carrier fluid, to hydraulically fracture the subterranean formation which defines a subsurface reservoir (e.g. a wellbore or reservoir itself). Here, the proppant props open the fractures in the subterranean formation after the hydraulic fracturing. In one embodiment, the proppant may also be used to filter unrefined petroleum fuels, e.g. crude oil, in fractures to improve feedstock quality for refineries. However, it is to be appreciated that the proppant of the subject invention can also have applications beyond hydraulic fracturing and crude oil filtration, including, but not limited to, water filtration and artificial turf.

The proppant comprises a particle and a hybrid coating disposed on the particle. As used herein, the terminology “disposed on” encompasses the hybrid coating being disposed about the particle and also encompasses both partial and complete covering of the particle by the hybrid coating. The hybrid coating is disposed on the particle to an extent sufficient to change the properties of the particle, e.g. to form a particle having a hybrid coating thereon which can be effectively used as a proppant. As such, any given sample of the proppant typically includes particles having the hybrid coating disposed thereon, and the hybrid coating is typically disposed on a large enough surface area of each individual particle so that the sample of the proppant can effectively prop open fractures in the subterranean formation during and after the hydraulic fracturing, filter crude oil, etc. The hybrid coating is described additionally below.

Although the particle may be of any size, the particle typically has a particle size distribution of from 10 to 100 mesh, more typically 20 to 70 mesh, as measured in accordance with standard sizing techniques using the United States Sieve Series. That is, the particle typically has a particle size of from 149 to 2,000, more typically of from 210 to 841, μm. Particles having such particle sizes allow less hybrid coating to be used, allow the hybrid coating to be applied to the particle at a lower viscosity, and allow the hybrid coating to be disposed on the particle with increased uniformity and completeness as compared to particles having other particle sizes.

Although the shape of the particle is not critical, particles having a spherical shape typically impart a smaller increase in viscosity to a hydraulic fracturing composition than particles having other shapes, as set forth in more detail below. The hydraulic fracturing composition is a mixture comprising the carrier fluid and the proppant. Typically, the particle is either round or roughly spherical.

The particle typically contains less than 1 part by weight of moisture, based on 100 parts by weight of the particle. Particles containing higher than 1 part by weight of moisture typically interfere with sizing techniques and prevent uniform coating of the particle.

Suitable particles for purposes of the subject invention include any known particle for use during hydraulic fracturing, water filtration, or artificial turf preparation. Non-limiting examples of suitable particles include minerals, ceramics such as sintered ceramic particles, sands, nut shells, gravels, mine tailings, coal ashes, rocks (such as bauxite), smelter slag, diatomaceous earth, crushed charcoals, micas, sawdust, wood chips, resinous particles, polymeric particles, and combinations thereof. It is to be appreciated that other particles not recited herein may also be suitable for the purposes of the subject invention.

Sand is a preferred particle and when applied in this technology is commonly referred to as frac, or fracturing, sand. Examples of suitable sands include, but are not limited to, Arizona sand, Badger sand, Brady sand, Northern White sand, and Ottawa sand. Based on cost and availability, inorganic materials such as sand and sintered ceramic particles are typically favored for applications not requiring filtration.

A specific example of a sand that is suitable as a particle for the purposes of the subject invention is Arizona sand, a natural grain that is derived from weathering and erosion of preexisting rocks. As such, this sand is typically coarse and is roughly spherical. Another specific example of a sand that is suitable as a particle for the purposes of this invention is Ottawa sand, commercially available from U.S. Silica Company of Berkeley Springs, W. Va. Yet another specific example of a sand that is suitable as a particle for the purposes of this invention is Wisconsin sand, commercially available from Badger Mining Corporation of Berlin, Wis. Particularly preferred sands for application in this invention are Ottawa and Wisconsin sands. Ottawa and Wisconsin sands of various sizes, such as 30/50, 20/40, 40/70, and 70/140 can be used.

Specific examples of suitable sintered ceramic particles include, but are not limited to, aluminum oxide, silica, bauxite, and combinations thereof. The sintered ceramic particle may also include clay-like binders.

An active agent may also be included in the particle. In this context, suitable active agents include, but are not limited to, organic compounds, microorganisms, and catalysts. Specific examples of microorganisms include, but are not limited to, anaerobic microorganisms, aerobic microorganisms, and combinations thereof. A suitable microorganism for the purposes of the subject invention is commercially available from LUCA Technologies of Golden, Colorado. Specific examples of suitable catalysts include fluid catalytic cracking catalysts, hydroprocessing catalysts, and combinations thereof. Fluid catalytic cracking catalysts are typically selected for applications requiring petroleum gas and/or gasoline production from crude oil. Hydroprocessing catalysts are typically selected for applications requiring gasoline and/or kerosene production from crude oil. It is also to be appreciated that other catalysts, organic or inorganic, not recited herein may also be suitable for the purposes of the subject invention.

Such additional active agents are typically favored for applications requiring filtration. As one example, sands and sintered ceramic particles are typically useful as a particle for support and propping open fractures in the subterranean formation which defines the subsurface reservoir, and, as an active agent, microorganisms and catalysts are typically useful for removing impurities from crude oil or water. Therefore, a combination of sands/sintered ceramic particles and microorganisms/catalysts as active agents are particularly preferred for crude oil or water filtration.

Suitable particles for purposes of the present invention may even be formed from resins and polymers. Specific examples of resins and polymers for the particle include, but are not limited to, polyurethanes, polycarbodiimides, polyureas, acrylics, polyvinylpyrrolidones, acrrylonitrile-butadiene styrenes, polystyrenes, polyvinyl chlorides, fluoroplastics, polysulfides, nylon, polyamide imides, and combinations thereof.

The particle is typically present in the proppant in an amount of from about 90 to about 99.5, more typically from about 94 to about 99, and most typically from about 95.5 to about 98.5, percent by weight based on the total weight of the proppant. The amount of the particle present in the proppant may vary outside of the ranges above, but is typically both whole and fractional values within these ranges.

As indicated above, the proppant includes the hybrid coating disposed on the particle. The hybrid coating is selected based on the desired properties and expected operating conditions of the proppant. The hybrid coating may provide the particle with protection from operating temperatures and pressures in the subterranean formation and/or subsurface reservoir. Further, the hybrid coating may protect the particle against closure stresses exerted by the subterranean formation. The hybrid coating may also protect the particle from ambient conditions and minimizes disintegration and/or dusting of the particle. In some embodiments, the hybrid coating may also provide the proppant with desired chemical reactivity and/or filtration capability.

The hybrid coating comprises the reaction product of an isocyanate component and an alkali metal silicate solution. The isocyanate component is typically selected such that the physical properties of the hybrid coating, such as hardness, strength, toughness, creep, and brittleness are optimized. The isocyanate component may include any type of isocyanate known to those skilled in the art. The isocyanate component may include one or more types of isocyanate. The isocyanate may be a polyisocyanate having two or more functional groups, e.g. two or more NCO functional groups. Suitable isocyanates for purposes of the present invention include, but are not limited to, aliphatic and aromatic isocyanates. In various embodiments, the isocyanate is selected from the group of diphenylmethane diisocyanates (MDIs), polymeric diphenylmethane diisocyanates (pMDIs), toluene diisocyanates (TDIs), hexamethylene diisocyanates (HDIs), isophorone diisocyanates (IPDIs), and combinations thereof.

Specific isocyanates that may be included in the isocyanate component include, but are not limited to, toluene diisocyanate; 4,4′-diphenylmethane diisocyanate; m-phenylene diisocyanate; 1,5-naphthalene diisocyanate; 4-chloro-1; 3-phenylene diisocyanate; tetramethylene diisocyanate; hexamethylene diisocyanate; 1,4-dicyclohexyl diisocyanate; 1,4-cyclohexyl diisocyanate, 2,4,6-toluylene triisocyanate, 1,3-diisopropylphenylene-2,4-dissocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxy-phenyl-2,5-diisocyanate; 1,3,5-triethyl benzene-2,4,6-triisocyanate; 1-ethyl-3,5-diisopropyl benzene-2,4,6-triisocyanate and 1,3,5-triisopropyl benzene-2,4,6-triisocyanate. Other suitable hybrid coatings can also be prepared from aromatic diisocyanates or isocyanates having one or two aryl, alkyl, aralkyl or alkoxy substituents wherein at least one of these substituents has at least two carbon atoms. Specific examples of suitable isocyanates include LUPRANATE® L5120, LUPRANATE® MM103, LUPRANATE® M, LUPRANATE® ME, LUPRANATE® MI, LUPRANATE® M20, and LUPRANATE® M70, all commercially available from BASF Corporation of Florham Park, N.J.

In one embodiment, the isocyanate is a polymeric isocyanate, such as LUPRANATE® M20. LUPRANATE® M20 comprises polymeric diphenylmethane diisocyanate and has an NCO content of about 31.5 weight percent.

The isocyanate component may include an isocyanate prepolymer. The isocyanate prepolymer is typically the reaction product of an isocyanate and a polyol and/or a polyamine. The isocyanate used in the prepolymer can be any isocyanate as described above. The polyol used to form the prepolymer is typically selected from the group of ethylene glycol, diethylene glycol, propylene glycol, dipropylene glycol, butane diol, glycerol, trimethylolpropane, triethanolamine, pentaerythritol, sorbitol, biopolyols, and combinations thereof. The polyamine used to form the prepolymer is typically selected from the group of ethylene diamine, toluene diamine, diaminodiphenylmethane and polymethylene polyphenylene polyamines, aminoalcohols, and combinations thereof. Examples of suitable amino alcohols include ethanolamine, diethanolamine, triethanolamine, and combinations thereof.

In one embodiment, the isocyanate prepolymer is the reaction product of LUPRANATE® M20 and PLURACOL® P2010. LUPRANATE® M20 is described above. PLURACOL® P2010 is a polyol that is commercially available from BASF Corporation of Florham Park, N.J. PLURACOL® P2010 has a hydroxyl number of from about 53.4 to about 58.6 mgKOH/g, a functionality of about 2, a molecular weight of about 2000 g/mol, and a viscosity of about 250 cps at 25° C. In this embodiment, about 80 parts by weight LUPRANATE® M20 and about 20 parts by weight PLURACOL® P2010, based on the total weight of all components used to form the isocyanate prepolymer, are combined and chemically react to form the isocyanate prepolymer.

The isocyanate component may include a polycarbodiimide prepolymer having isocyanate functionality. For purposes of the present invention, the polycarbodiimide prepolymer includes one or more carbodiimide units and one or more isocyanate functional groups. Typically, the polycarbodiimide prepolymer has an NCO content of about 5 to about 50, more typically of about 10 to about 40, and most typically of about 15 to about 35, weight percent.

Typically, the polycarbodiimide prepolymer is formed by reacting the isocyanate in the presence of a catalyst. That is, the polycarbodiimide prepolymer may comprise the reaction product of the isocyanate reacted in the presence of the catalyst. The polycarbodiimide prepolymer can be the reaction product of one type of isocyanate. However, for this invention, the polycarbodiimide prepolymer can also be the reaction product of at least two different types of isocyanate. Obviously, the polycarbodiimide prepolymer may be the reaction product of more than two types of isocyanates.

As indicated above, multiple isocyanates may be reacted to form the polycarbodiimide prepolymer. When one or more isocyanates are reacted to form the polycarbodiimide prepolymer, the physical properties of the hybrid coating formed therefrom, such as hardness, strength, toughness, creep, and brittleness can be further optimized and balanced.

In one embodiment, a mixture of a first isocyanate, such as a polymeric isocyanate, and a second isocyanate, such as a monomeric isocyanate, different from the first isocyanate, are reacted in the presence of the catalyst to form the polycarbodiimide prepolymer. As is known in the art, polymeric isocyanate includes isocyanates with two or more aromatic rings. As is also known in the art, monomeric isocyanates include, but are not limited to, 2,4′-diphenylmethane diisocyanate (2,4′-MDI) and 4,4′-diphenylmethane diisocyanate (4,4′-MDI). For example, a mixture of LUPRANATE® M20 and LUPRANATE® M may be reacted to form the polycarbodiimide prepolymer. LUPRANATE® M20 comprises polymeric isocyanates, such as polymeric diphenyl methane diisocyanate, and also comprises monomeric isocyanates. LUPRANATE® M comprises only monomeric isocyanates, such as 4,4′-diphenylmethane diisocyanate. LUPRANATE® M20 has an NCO content of about 31.5 weight percent and LUPRANATE® M has an NCO content of about 33.5 weight percent. Increasing an amount of LUPRANATE® M20 in the mixture increases the amount of polymeric MDI in the mixture, and increasing the amount of polymeric MDI in the mixture affects the physical properties of the polycarbodiimide prepolymer and the hybrid coating formed therefrom.

In a preferred embodiment, the polymeric isocyanate, such as LUPRANATE® M20, is typically reacted in an amount of from about 20 to about 100, more typically from about 40 to about 80, most typically from about 60 to about 70, percent by weight and the monomeric isocyanate, such as LUPRANATE® M, is typically reacted in an amount of from about 20 to about 80, more typically from about 25 to about 60, most typically from about 30 to about 40, percent by weight, both based on a total combined weight of the polymeric and monomeric isocyanates to form the polycarbodiimide prepolymer. In yet another preferred embodiment, the polymeric isocyanate and the monomeric isocyanate react in a weight ratio of 4:1 to 1:4, more typically 2.5:1 to 1:1, and even more typically 2.0:1, to form the polycarbodiimide prepolymer.

The one or more isocyanates are typically heated in the presence of the catalyst to form the polycarbodiimide prepolymer. The catalyst may be any type of catalyst known to those skilled in the art. Generally, the catalyst is selected from the group of phosphorous compounds, tertiary amides, basic metal compounds, carboxylic acid metal salts, non-basic organo-metallic compounds, and combinations thereof. For example, the one or more isocyanates may be heated in the presence of a phosphorous compound to form the polycarbodiimide coating. Suitable examples of the phosphorous compound include, but are not limited to, phospholene oxides such as 3-methyl-1-phenyl-2-phospholene oxide, 1-phenyl-2-phospholen-1-oxide, 3-methyl-1-2-pho spholen-1-oxide, 1-ethyl-2-phospholen-1-oxide, 3-methyl-1-phenyl-2-phospholen-1-oxide, and 3-phospholene isomers thereof. A particularly suitable phospholene oxide is 3-methyl-1-phenyl-2-phospholene oxide, represented by the following structure:

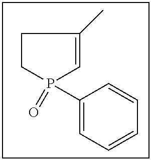

The catalyst may be present in any amount sufficient to catalyze the reaction between the isocyanates. In a particularly preferred embodiment, 3-methyl-1-phenyl-2-phospholene oxide is typically present in the polycarbodiimide prepolymer in an amount of greater than about 1, more typically of from about 2 to about 5000, and most typically of from about 3 to about 600, PPM.

The polycarbodiimide prepolymer can also be formed by heating a carbodiimide modified 4,4′-diphenylmethane diisocyanate to a reaction temperature of greater than about 150° C. That is, the polycarbodiimide prepolymer may comprise the reaction product of a carbodiimide modified 4,4′-diphenylmethane diisocyanate heated to a reaction temperature of greater than about 150° C. Specific examples of suitable carbodiimide modified 4,4′-diphenylmethane diisocyanates include LUPRANATE® L5120 and LUPRANATE® MM103, both commercially available from BASF Corporation of Florham Park, N.J.

In one embodiment, the isocyanate prepolymer is the reaction product of LUPRANATE® MM103 which is heated to a temperature of about 150° C. for greater than 2 hours. LUPRANATE® MM103 is a carbodiimide modified 4,4′-diphenylmethane diisocyanate having an NCO content of about 29.5 weight percent.

Specific polycarbodiimide prepolymers which are suitable for the purposes of the subject invention may include monomers, oligomers, and polymers of diisopropylcarbodiimide, dicyclohexylc abodiimide, methyl-tert-butylcarbodiimide, 2,6-diethylphenyl carbodiimide; di-ortho-tolyl-carbodimide; 2,2′-dimethyl diphenyl carbodiimide; 2,2′-diisopropyl-diphenyl carbodiimide; 2-dodecyl-2′-n-propyl-diphenylcarbodiimide; 2,2′-diethoxy-diphenyl dichloro-diphenylcarbodiimide; 2,2′-ditolyl-diphenyl carbodiimide; 2,2′-dibenzyl-diphenyl carbodiimide; 2,2′-dinitro-diphenyl carbodiimide; 2-ethyl-2′-isopropyl-diphenyl carbodiimide; 2,6,2′,6′-tetraethyl-diphenyl carbodiimide; 2,6,2′,6′-tetras econdary-butyl-diphenyl carbodiimide; 2,6,2′,6′-tetraethyl-3,3′-dichloro-diphenyl carbodiimide; 2-ethyl-cyclohexyl-2-isopropylphenyl carbodiimide; 2,4,6,2′,4′,6′-hexaisopropyl-diphenyl carbodiimide; 2,2′-diethyl-dicyclohexyl carbodiimide; 2,6,2′,6′-tetraisopropyl-dicyclohexyl carbodiimide; 2,6,2′,6′tetraethyl-dicyclohexy) carbodiimide and 2,2′-dichlorodicyclohexyl carbodiimide; 2,2′-dicarbethoxy diphenyl carbodiimide; 2,2′-dicyano-diphenyl carbodiimide and the like.

The isocyanate component is typically reacted, to form the hybrid coating, in an amount of from about 10 to about 80, more typically from about 20 to about 70 and most typically from about 30 to about 55, percent by weight based on the total weight of the hybrid coating. The amount of isocyanate component which is reacted to form the hybrid coating may vary outside of the ranges above, but is typically both whole and fractional values within these ranges.

The alkali metal silicate solution, which is reacted with the isocyanate component, includes water and an alkali metal silicate. The isocyanate can react with both the water and the alkali metal silicate. It is possible to use commercial-grade alkali metal silicate solutions which can additionally include, for example, calcium silicate, magnesium silicate, borates, and aluminates. It is also possible to make the alkali metal silicate solution in situ by using a combination of solid alkali metal silicate and water.

The alkali metal silicate is typically present in the alkali metal silicate solution in an amount of from about 5 to about 70, more typically from about 10 to about 55, and most typically from about 15 to about 40, percent by weight based on the total weight of the alkali metal silicate solution. Further, the alkali metal silicate solution typically has a viscosity of from about 50 to about 1,000, more typically from about 75 to about 750, and most typically from about 100 to about 500, centipoise at 25° C. The amount of alkali metal silicate present in the alkali metal silicate solution and the viscosity of the alkali metal silicate solution may vary outside of the ranges above, but is typically both whole and fractional values within these ranges.

Examples of suitable alkali metal silicates include, but are not limited to, sodium silicate, potassium silicate, lithium silicate, or the like. Typically, the alkali metal silicate is sodium silicate. As is known in the art, the sodium silicate in solution may also be referred to as “water glass” or “liquid glass.” The alkali metal silicate typically has a M₂O:SiO₂ ratio from about 1 to about 4, more typically of from about 1.6 to about 3.2, and most typically of from 2 to about 3. Wherein M refers to the alkali metal.

In one embodiment, the alkali metal silicate solution includes sodium silicate in an amount of from about 15 to about 40 percent by weight based on the total weight of the alkali metal silicate solution and has a viscosity of from about 250 to about 500 centipoise. A specific, non limiting example of one such alkali metal silicate solution is MEYCO® MP 364 Part A, which is commercially available from

BASF Corporation of Florham Park, N.J.

The alkali metal silicate solution may also include a polyol. That is, the hybrid coating can comprise the reaction product of a polyol in addition to the isocyanate component and the alkali metal silicate solution. Of course, if the polyol is reacted to form the hybrid coating, the polyol does not necessarily have to be included in the alkali metal silicate solution. The polyol may include one or more polyols. The polyol includes one or more OH functional groups, typically at least two OH functional groups. Typically, the polyol is selected from the group of polyether polyols, polyester polyols, polyether/ester polyols, and combinations thereof; however, other polyols, such as biopolyols, may also be employed.

If included, the polyol typically has a number average molecular weight of greater than about 100, more typically from about 130 to about 1,000, and most typically from about 160 to about 460, g/mol; typically has a viscosity of less than about 500, more typically of from about 5 to about 150, and most typically from about 100 to about 130, centipoise at 38° C.; typically has a nominal functionality of greater than about 1.5, more typically from about 1.7 to about 5, and most typically from about 1.9 to about 3.1; and typically has a hydroxyl value of from about 100 to about 1,300, more typically of from about 150 to about 800, and most typically of from about 200 to about 400, mgKOH/g. The number average molecular weight, viscosity, hydroxyl value, and functionality of the polyol may vary outside of the ranges above, but are typically both whole and fractional values within those ranges.

The alkali metal silicate solution may also include an amine That is, the hybrid coating can comprise the reaction product of an amine in addition to the isocyanate component and the alkali metal silicate solution. Of course, if the amine is reacted with the isocyanate component and the alkali metal silicate solution to form the hybrid coating, the amine does not necessarily have to be included in the alkali metal silicate solution. The amine can be an aliphatic or aromatic and is typically multi-functional. In one embodiment, the amine can be combined with the isocyanate component comprising monomeric or polymeric isocyanate and the alkali metal silicate solution and the amine will react with the isocyanate component to form an isocyanate prepolymer in situ, which will, in turn, react with the sodium silicate solution to for the hybrid coating.

In one embodiment, the alkali metal silicate solution includes UNILINK™ 4200, which is commercially available from UOP of Des Plaines, Ill. UNILINK™ 4200 is an aromatic diamine having hydroxy functionality. In this embodiment, the alkali metal silicate solution including the polyol is mixed with the isocyanate component comprising monomeric and/or polymeric isocyanates, such as LUPRANATE® M and LUPRANATE® M20. When the alkali metal silicate solution is mixed with the isocyanate component, the polyol and the monomeric and/or polymeric isocyanates chemically react to form an isocyanate prepolymer in situ, which further reacts with the sodium silicate and the water to form the hybrid coating.

The alkali metal silicate solution is typically reacted, to form the hybrid coating, in an amount of from about 30 to about 90, more typically from about 40 to about 70 and most typically from about 45 to about 65, percent by weight based on the total weight of all components reacted to for said hybrid coating. The amount of the alkali metal silicate solution which is reacted to form the hybrid coating may vary outside of the ranges above, but is typically both whole and fractional values within these ranges.

The hybrid coating may also include a catalyst. More specifically, the isocyanate component and the alkali metal silicate solution can be chemically reacted in the presence of the catalyst to form the hybrid coating. The catalyst can be used to catalyze the reaction between the isocyanate component and the alkali metal silicate solution. For example, a catalyst can be used to increase reaction rates between the isocyanate component and the alkali metal silicate solution. For instance, the catalyst can be used to increase the reaction rate between the isocyanate and the water of the alkali metal silicate solution. The hybrid coating may optionally include more than one catalyst. The catalyst may include any suitable catalyst or mixtures of catalysts known in the art. If present, the catalyst may be present in the hybrid coating in any amount sufficient to catalyze the reaction between the isocyanate component and the alkali metal silicate solution.

The hybrid coating may further include additives. Suitable additives include, but are not limited to, surfactants, blowing agents, wetting agents, blocking agents, dyes, pigments, diluents, solvents, specialized functional additives such as antioxidants, ultraviolet stabilizers, biocides, adhesion promoters, antistatic agents, fire retardants, fragrances, and combinations of the group. For example, a pigment allows the hybrid coating to be visually evaluated for thickness and integrity and can provide various marketing advantages. Also, physical blowing agents and chemical blowing agents are typically selected for hybrid coatings requiring foaming. That is, in one embodiment, the coating may comprise a foam coating disposed on the particle. Again, it is to be understood that the terminology “disposed on” encompasses both partial and complete covering of the particle by the hybrid coating, a foam coating in this instance. The foam coating is typically useful for applications requiring enhanced contact between the proppant and crude oil. That is, the foam coating typically defines microchannels and increases a surface area for contact between crude oil and the catalyst and/or microorganism.

The hybrid coating is typically selected for applications requiring excellent coating stability and adhesion to the particle. Further, hybrid coating is typically selected based on the desired properties and expected operating conditions of a particular application. The hybrid coating is chemically and physically stable over a range of temperatures and does not typically melt, degrade, and/or shear off the particle in an uncontrolled manner when exposed to higher pressures and temperatures, e.g. pressures and temperatures greater than pressures and temperatures typically found on the earth's surface. As one example, the hybrid coating is particularly applicable when the proppant is exposed to significant pressure, compression and/or shear forces, and temperatures exceeding 200° C. in the subterranean formation and/or subsurface reservoir defined by the formation. The hybrid coating is generally viscous to solid nature, and depending on molecular weight. Any suitable hybrid coating may be used for the purposes of the subject invention.

The hybrid coating is typically present in the proppant in an amount of from about 0.5 to about 10, more typically from about 1 to about 6, and most typically from about 1.5 to about 4.5, percent by weight based on the total weight of the proppant. The amount of hybrid coating present in the proppant may vary outside of the ranges above, but is typically both whole and fractional values within these ranges. Further, the hybrid coating is typically present in the proppant in an amount of from about 0.5 to about 11, more typically from about 1 to about 6, and most typically from about 1.5 to about 4.5, percent by weight based on the total weight of the particle. The amount of hybrid coating present in the proppant may vary outside of the ranges above, but is typically both whole and fractional values within these ranges.

The hybrid coating may be formed in-situ where the hybrid coating is disposed on the particle during formation of the hybrid coating. Said differently, the components of the hybrid coating are typically combined with the particle and the hybrid coating is disposed on the particle.

However, in one embodiment a hybrid coating is formed and some time later applied to, e.g. mixed with, the particle and exposed to temperatures exceeding 100° C. to coat the particle and form the proppant. Advantageously, this embodiment allows the hybrid coating to be formed at a location designed to handle chemicals, under the control of personnel experienced in handling chemicals. Once formed, the hybrid coating can be transported to another location, applied to the particle, and heated. There are numerous logistical and practical advantages associated with this embodiment. For example, if the hybrid coating is being applied to the particle, e.g. frac sand, the hybrid coating may be applied immediately following the manufacturing of the frac sand.

In another embodiment, the hybrid coating may also be further defined as controlled-release. That is, the hybrid coating may systematically dissolve, hydrolyze in a controlled manner, or physically expose the particle to the petroleum fuels in the subsurface reservoir. The hybrid coating typically gradually dissolves in a consistent manner over a pre-determined time period to decrease the thickness of the hybrid coating. This embodiment is especially useful for applications utilizing the active agent such as the microorganism and/or the catalyst. That is, the hybrid coating is typically controlled-release for applications requiring filtration of petroleum fuels or water.

The hybrid coating may exhibit excellent non-wettability in the presence of water, as measured in accordance with standard contact angle measurement methods known in the art. The hybrid coating may have a contact angle of greater than 90° and may be categorized as hydrophobic. Consequently, the proppant of such an embodiment can partially float in the subsurface reservoir and is typically useful for applications requiring foam coatings.

The hybrid coating of the present invention can be crosslinked where it is cured prior to pumping of the proppant into the subsurface reservoir, or the hybrid coating can be curable whereby the hybrid coating cures in the subsurface reservoir due to the conditions inherent therein. These concepts are described further below.

The proppant of the subject invention may comprise the particle encapsulated with a crosslinked hybrid coating. The crosslinked hybrid coating typically provides crush strength, or resistance, for the proppant and prevents agglomeration of the proppant. Since the crosslinked hybrid coating is cured before the proppant is pumped into a subsurface reservoir, the proppant typically does not crush or agglomerate even under high pressure and temperature conditions.

Alternatively, the proppant of the subject invention may comprise the particle encapsulated with a curable hybrid coating. The curable hybrid coating typically consolidates and cures subsurface. The curable hybrid coating is typically not crosslinked, i.e., cured, or is partially crosslinked before the proppant is pumped into the subsurface reservoir. Instead, the curable hybrid coating typically cures under the high pressure and temperature conditions in the subsurface reservoir. Proppants comprising the particle encapsulated with the curable hybrid coating are often used for high pressure and temperature conditions.

Additionally, proppants comprising the particle encapsulated with the curable hybrid coating may be classified as curable proppants, subsurface-curable proppants and partially-curable proppants. Subsurface-curable proppants typically cure entirely in the subsurface reservoir, while partially-curable proppants are typically partially cured before being pumped into the subsurface reservoir. The partially-curable proppants then typically fully cure in the subsurface reservoir. The proppant of the subject invention can be either subsurface-curable or partially-curable.

Multiple layers of the hybrid coating can be applied to the particle to form the proppant. As such, the proppant of the subject invention can comprise a particle having a crosslinked hybrid coating disposed on the particle and a curable hybrid coating disposed on the crosslinked coating, and vice versa. Likewise, multiple layers of the hybrid coating, each individual layer having the same or different physical properties can be applied to the particle to form the proppant. In addition, the hybrid coating can be applied to the particle in combination with coatings comprising different polymeric and other materials such as polyurethane, polycarbodiimide, polyamide imide, and other materials.

As alluded to above, the proppant may further include an additive such as a silicon-containing adhesion promoter. This adhesion promoter is also commonly referred to in the art as a coupling agent or as a binder agent. The adhesion promoter binds the hybrid coating to the particle. More specifically, the adhesion promoter typically has organofunctional silane groups to improve adhesion of the hybrid coating to the particle. Without being bound by theory, it is thought that the adhesion promoter allows for covalent bonding between the particle and the hybrid coating. In one embodiment, the surface of the particle is activated with the adhesion promoter by applying the adhesion promoter to the particle prior to coating the particle with the hybrid coating. In this embodiment, the adhesion promoter can be applied to the particle by a wide variety of application techniques including, but not limited to, spraying, dipping the particles in the hybrid coating, etc. In another embodiment, the adhesion promoter may be added to a component such as alkali metal silicate solution. As such, the particle is then simply exposed to the adhesion promoter when the hybrid coating is applied to the particle. The adhesion promoter is useful for applications requiring excellent adhesion of the hybrid coating to the particle, for example, in applications where the proppant is subjected to shear forces in an aqueous environment. Use of the adhesion promoter provides adhesion of the hybrid coating to the particle such that the hybrid coating will remain adhered to the surface of the particle even if the proppant, including the hybrid coating, the particle, or both, fractures due to closure stress.

Examples of suitable adhesion promoters, which are silicon-containing, include, but are not limited to, glycidoxypropyltrimethoxysilane, aminoethylaminopropyltrimethoxysilane, methacryloxypropyltrimethoxysilane, gamma-aminopropyltriethoxysilane, vinylbenzylaminoethylaminopropyltrimethoxysilane, glycidoxypropylmethyldiethoxysilane, chloropropyltrimethoxysilane, phenyltrimethoxysilane, vinyltriethoxysilane, tetraethoxysilane, methyldimethoxysilane, bis-triethoxysilylpropyldisulfidosilane, bis-triethoxysilylpropyltetrasulfidosilane, phenyltriethoxysilane, amino silanes, and combinations thereof.

Specific examples of suitable adhesion promoters include, but are not limited to, SILQUEST™ A1100, SILQUEST™ A1110, SILQUEST™ A1120, SILQUEST™ 1130, SILQUEST™ A1170, SILQUEST™ A-189, and SILQUESTυ Y9669, all commercially available from Momentive Performance Materials of Albany, N.Y. A particularly suitable silicon-containing adhesion promoter is SILQUEST™ A1100, i.e., gamma-aminopropyltriethoxysilane. The silicon-containing adhesion promoter may be present in the proppant in an amount of from about 0.001 to about 10, typically from about 0.01 to about 5, and more typically from about 0.02 to about 1.25, percent by weight based on the total weight of the proppant. The amount silicon-containing adhesion promoter present in the proppant may vary outside of the ranges above, but is typically both whole and fractional values within these ranges.

As is also alluded to above, the proppant may further include an additive such as a wetting agent. The wetting agent is also commonly referred to in the art as a surfactant. The proppant may include more than one wetting agent. The wetting agent may include any suitable wetting agent or mixtures of wetting agents known in the art. The wetting agent is employed to increase a surface area contact between the hybrid coating and the particle. In a typical embodiment, the wetting agent is added to a component such as the isocyanate component or the alkali metal silicate solution. In another embodiment, the surface of the particle is activated with the wetting agent by applying the wetting agent to the particle prior to coating the particle with the hybrid coating.

A suitable wetting agent is BYK® 310, a polyester modified poly-dimethyl-siloxane, commercially available from BYK Additives and Instruments of Wallingford, Conn. The wetting agent may be present in the proppant in an amount of from about 0.001 to about 10, typically from about 0.002 to about 5, and more typically from about 0.004 to about 2, percent by weight based on the total weight of the proppant. The amount of wetting agent present in the proppant may vary outside of the ranges above, but is typically both whole and fractional values within these ranges.

The hybrid coating of this invention may also include the active agent already described above in the context of the particle. In other words, the active agent may be included in the hybrid coating independent of the particle. Once again, suitable active agents include, but are not limited to organic compounds, microorganisms, and catalysts.

The proppant of the subject invention typically exhibits excellent thermal stability for high temperature and pressure applications, e.g. temperatures greater than 150, more typically greater than 200, and most typically greater than 230,° C., and/or pressures (independent of the temperatures described above) greater than 7,500 psi, typically greater than 10,000 psi, more typically greater than 12,500 psi, and even more typically greater than 15,000 psi. The proppant of this invention does not suffer from complete failure of the hybrid coating due to shear or degradation when exposed to such temperatures and pressures.

Further, with the hybrid coating of this invention, the proppant typically exhibits excellent crush strength, also commonly referred to as crush resistance. With this crush strength, the hybrid coating of the proppant is uniform and is substantially free from defects, such as gaps or indentations, which often contribute to premature breakdown and/or failure of the hybrid coating. In particular, the proppant exhibits a crush strength of 10% or less maximum fines as measured in accordance with American Petroleum Institute (API) RP60 at specific stress pressures of 8000 and 10,000 psi.

When 40/70 Northern White sand is utilized as the particle, a crush strength associated with the proppant of this invention is typically less than 15%, more typically less than 10%, and most typically less than 5% maximum fines less than 70 mesh as measured in accordance with API RP60 at the same stress pressure range and specific stress pressures described above. In one embodiment where 40/70 Northern White sand is utilized as the particle, the crush strength of this proppant is less than 5% fines as measured in accordance with API RP60 at 8000 psi and at a temperature of from about 22 to about 24° C. In another embodiment where 40/70 Northern White sand is utilized as the particle, the crush strength of this proppant is less than 12% fines as measured in accordance with API RP60 at 10,000 psi and at a temperature of from about 22 to about 24° C.

In addition to testing crush strength in accordance with the parameters set forth in API RP60, the crush strength of the proppant can be tested with various other testing parameters. For example, a sample of the proppant can be sieved to a sieve size of greater than 35. Once sieved and tested, the proppant of the present invention typically has a crush strength of about 10, more typically about 7.5, and most typically about 5, %, or less maximum fines less than sieve size 70 as measured by compressing a 23.78 g sample (loading density of 4 lb/ft²)of the proppant in a test cylinder having a diameter of 1.5 inches for 1 hour at 8000 psi and about 123° C. (250° F.).

The hybrid coating of this invention typically provides a cushioning effect for the proppant and evenly distributes high pressures, e.g. closure stresses, around the proppant. Therefore, the proppant of the subject invention effectively props open fractures and minimizes unwanted impurities in unrefined petroleum fuels in the form of dust particles.

Although customizable according to carrier fluid selection, the proppant typically has a bulk specific gravity of from about 0.1 to about 3.0, more typically from about 1.0 to about 2.0. One skilled in the art typically selects the specific gravity of the proppant according to the specific gravity of the carrier fluid and whether it is desired that the proppant be lightweight or substantially neutrally buoyant in the selected carrier fluid. In particular, it is desired that the specific gravity of the proppant is less than the specific gravity of the carrier fluid to minimize proppant settling in the carrier fluid. Further, based on the non-wettability of the hybrid coating including crosslinks as set forth above, the proppant of such an embodiment typically has an apparent density, i.e., a mass per unit volume of proppant, of from about 2.0 to about 3.0, more typically from about 2.3 to about 2.7, g/cm³ according to API Recommended Practices RP60 for testing proppants. It is believed that the non-wettability of the hybrid coating may contribute to flotation of the proppant depending on the selection of the carrier fluid in the wellbore.

Further, the proppant typically minimizes unpredictable consolidation. That is, the proppant only consolidates, if at all, in a predictable, desired manner according to carrier fluid selection and operating temperatures and pressures. Also, the proppant is typically compatible with low-viscosity carrier fluids having viscosities of less than about 3,000 cps at 80° C. and is typically substantially free from mechanical failure and/or chemical degradation when exposed to the carrier fluids and high pressures. Finally, the proppant is typically coated via economical coating processes and typically does not require multiple coating layers, and therefore minimizes production costs.

As set forth above, the subject invention also provides the method of forming, or preparing, the proppant. For this method, the particle, the isocyanate component, and the alkali metal silicate solution are provided. As with all other components which may be used in the method of the subject invention (e.g. the particle), the isocyanate component and the alkali metal silicate solution are just as described above with respect to the hybrid coating. The isocyanate component, and the alkali metal silicate solution are combined and react to form the hybrid coating and the particle is coated with the hybrid coating to form the proppant.

In one embodiment, the isocyanate component comprises an isocyanate prepolymer which comprises the reaction product of an isocyanate and a polyol. The method of this embodiment can include the step of combining the isocyanate and the polyol to form the isocyanate prepolymer as is described above.

In another embodiment, the isocyanate component comprises a polycarbodiimide prepolymer having isocyanate functionality which comprises the reaction product of an isocyanate in the presence of a catalyst. The method of this embodiment can include the step of combining the isocyanate and the catalyst to form the polycarbodiimide prepolymer as is described above. The method of this embodiment can further include the step of combining the isocyanate and the catalyst to form a reaction mixture and heating the reaction mixture to a temperature of greater than 100° C. to form the polycarbodiimide prepolymer.

In yet another embodiment, the isocyanate component comprises a polycarbodiimide prepolymer having isocyanate functionality which comprises the reaction product of a carbodiimide modified 4,4′-diphenylmethane diisocyanate heated to a reaction temperature of greater than about 150° C.

As indicated in certain embodiments below, the isocyanate component and the alkali metal silicate solution may be combined to form the hybrid coating prior to the coating of the particle. Alternatively, the isocyanate component and the alkali metal silicate solution may be combined to form the hybrid coating simultaneous with the coating of the particle.

The step of combining the isocyanate component and the alkali metal silicate solution is conducted at a reaction temperature. At the reaction temperature, the isocyanate component and the alkali metal silicate solution chemically react to form the hybrid coating. The reaction temperature is typically greater than −10, more typically from about 0 to about 45, and still more typically from about 10 to about 40° C. Most typically, the reaction temperature occurs at ambient temperatures (i.e., at about 22° C.,) which is beneficial in view of energy consumption required to form the proppant.

The particle is coated with the hybrid coating to form the proppant. The hybrid coating is applied to the particle to coat the particle. The particle may optionally be heated to a temperature greater than 50° C. prior to or simultaneous with the step of coating the particle with the hybrid coating. If heated, a preferred temperature range for heating the particle is typically from about 50 to about 180° C.

Various techniques can be used to coat the particle with the hybrid coating. These techniques include, but are not limited to, mixing, pan coating, fluidized-bed coating, co-extrusion, spraying, in-situ formation of the hybrid coating, and spinning disk encapsulation. The technique for applying the hybrid coating to the particle is selected according to cost, production efficiencies, and batch size.

In this method, the steps of combining the isocyanate component and the alkali metal silicate solution and coating the particle with the hybrid coating to form the proppant are typically collectively conducted in 30 minutes or less, more typically in 20 minutes or less, still more typically in 10 minutes or less, and most typically in 4 minutes or less. Further, the steps of combining the isocyanate component and the alkali metal silicate solution to react and form the hybrid coating and coating the particle with the hybrid coating to form the proppant are typically conducted at a temperature of from about −10 to about 50, more typically from about 0 to about 45, and most typically from about 10 to about 40° C.

In one embodiment, the hybrid coating is disposed on the particle via mixing in a vessel, e.g. a reactor. In particular, the individual components of the proppant, e.g. the isocyanate component, the alkali metal silicate solution, and the particle, are added to the vessel to form a reaction mixture. The components may be added in equal or unequal weight ratios. The reaction mixture is typically agitated at an agitator speed commensurate with the viscosities of the components. Further, the reaction mixture is typically heated at a temperature commensurate with the hybrid coating technology and batch size. It is to be appreciated that the technique of mixing may include adding components to the vessel sequentially or concurrently. Also, the components may be added to the vessel at various time intervals and/or temperatures.

In another embodiment, the hybrid coating is disposed on the particle via spraying. In particular, individual components of the hybrid coating are contacted in a spray device to form a coating mixture. The coating mixture is then sprayed onto the particle to form the proppant. Spraying the hybrid coating onto the particle can result in a uniform, complete, and defect-free hybrid coating disposed on the particle. For example, the hybrid coating is typically even and unbroken. The hybrid coating also typically has adequate thickness and acceptable integrity, which allows for applications requiring controlled-release of the proppant in the fracture. Spraying also typically results in a thinner and more consistent hybrid coating disposed on the particle as compared to other techniques, and thus the proppant is coated economically. Spraying the particle even permits a continuous manufacturing process. Spray temperature is typically selected by one known in the art according to hybrid coating technology and ambient humidity conditions. The particle may also be heated to induce crosslinking of the hybrid coating. Further, one skilled in the art typically sprays the components of the hybrid coating at a viscosity commensurate with the viscosity of the components.

In another embodiment, the hybrid coating is disposed on the particle in-situ, i.e., in a reaction mixture comprising the components of the hybrid coating and the particle. In this embodiment, the hybrid coating is formed or partially formed as the hybrid coating is disposed on the particle. In-situ hybrid coating formation steps typically include providing each component of the hybrid coating, providing the particle, combining the components of the hybrid coating and the particle, and disposing the hybrid coating on the particle. In-situ formation of the hybrid coating typically allows for reduced production costs by way of fewer processing steps as compared to existing methods for forming a proppant.

The formed proppant is typically prepared according to the method as set forth above and stored in an offsite location before being pumped into the subterranean formation and the subsurface reservoir. As such, coating typically occurs offsite from the subterranean formation and subsurface reservoir. However, it is to be appreciated that the proppant may also be prepared just prior to being pumped into the subterranean formation and the subsurface reservoir. In this scenario, the proppant may be prepared with a portable coating apparatus at an onsite location of the subterranean formation and subsurface reservoir.

A method of hydraulically fracturing a subterranean formation which defines a subsurface reservoir with a mixture comprising a carrier fluid and the proppant is also disclosed. That is, the proppant is useful for hydraulic fracturing of the subterranean formation to enhance recovery of petroleum and the like. In a typical hydraulic fracturing operation, a hydraulic fracturing composition, i.e., a mixture comprising the carrier fluid, the proppant, and optionally various other components, is prepared. The carrier fluid is selected according to wellbore conditions and is mixed with the proppant to form the mixture which is the hydraulic fracturing composition. The carrier fluid can be a wide variety of fluids including, but not limited to, kerosene and water. Typically, the carrier fluid is water. Various other components which can be added to the mixture include, but are not limited to, guar, polysaccharides, and other components know to those skilled in the art.

The mixture is pumped into the subsurface reservoir, which may be the wellbore, to cause the subterranean formation to fracture. More specifically, hydraulic pressure is applied to introduce the hydraulic fracturing composition under pressure into the subsurface reservoir to create or enlarge fractures in the subterranean formation. When the hydraulic pressure is released, the proppant holds the fractures open, thereby enhancing the ability of the fractures to extract petroleum fuels or other subsurface fluids from the subsurface reservoir to the wellbore.

For the method of filtering a fluid, the proppant of the subject invention is provided according to the method of forming the proppant as set forth above. In one embodiment, the subsurface fluid can be unrefined petroleum or the like. However, it is to be appreciated that the method of the subject invention may include the filtering of other subsurface fluids not specifically recited herein, for example, air, water, or natural gas.

To filter the subsurface fluid, the fracture in the subsurface reservoir that contains the unrefined petroleum, e.g. unfiltered crude oil, is identified by methods known in the art of oil extraction. Unrefined petroleum is typically procured via a subsurface reservoir, such as a wellbore, and provided as feedstock to refineries for production of refined products such as petroleum gas, naphtha, gasoline, kerosene, gas oil, lubricating oil, heavy gas, and coke. However, crude oil that resides in subsurface reservoirs includes impurities such as sulfur, undesirable metal ions, tar, and high molecular weight hydrocarbons. Such impurities foul refinery equipment and lengthen refinery production cycles, and it is desirable to minimize such impurities to prevent breakdown of refinery equipment, minimize downtime of refinery equipment for maintenance and cleaning, and maximize efficiency of refinery processes. Therefore, filtering is desirable.

For the method of filtering, the hydraulic fracturing composition is pumped into the subsurface reservoir so that the hydraulic fracturing composition contacts the unfiltered crude oil. The hydraulic fracturing composition is typically pumped into the subsurface reservoir at a rate and pressure such that one or more fractures are formed in the subterranean formation. The pressure inside the fracture in the subterranean formation may be greater than 5,000, greater than 7,000, or even greater than 10,000 psi, and the temperature inside the fracture is typically greater than 70° F. and can be as high 375° F. depending on the particular subterranean formation and/or subsurface reservoir.

Although not required for filtering, it is particularly desirable that the proppant be a controlled-release proppant. With a controlled-release proppant, while the hydraulic fracturing composition is inside the fracture, the hybrid coating of the proppant typically dissolves in a controlled manner due to pressure, temperature, pH change, and/or dissolution in the carrier fluid in a controlled manner, i.e., a controlled-release. Complete dissolution of the hybrid coating depends on the thickness of the hybrid coating and the temperature and pressure inside the fracture, but typically occurs within 1 to 4 hours. It is to be understood that the terminology “complete dissolution” generally means that less than 1% of the coating remains disposed on or about the particle. The controlled-release allows a delayed exposure of the particle to crude oil in the fracture. In the embodiment where the particle includes the active agent, such as the microorganism or catalyst, the particle typically has reactive sites that must contact the fluid, e.g. the crude oil, in a controlled manner to filter or otherwise clean the fluid. If implemented, the controlled-release provides a gradual exposure of the reactive sites to the crude oil to protect the active sites from saturation. Similarly, the active agent is typically sensitive to immediate contact with free oxygen. The controlled-release provides the gradual exposure of the active agent to the crude oil to protect the active agent from saturation by free oxygen, especially when the active agent is a microorganism or catalyst.

To filter the fluid, the particle, which is substantially free of the hybrid coating after the controlled-release, contacts the subsurface fluid, e.g. the crude oil. It is to be understood that the terminology “substantially free” means that complete dissolution of the hybrid coating has occurred and, as defined above, less than 1% of the hybrid coating remains disposed on or about the particle. This terminology is commonly used interchangeably with the terminology “complete dissolution” as described above. In an embodiment where an active agent is utilized, upon contact with the fluid, the particle typically filters impurities such as sulfur, unwanted metal ions, tar, and high molecular weight hydrocarbons from the crude oil through biological digestion. As noted above, a combination of sands/sintered ceramic particles and microorganisms/catalysts are particularly useful for filtering crude oil to provide adequate support/propping and also to filter, i.e., to remove impurities. The proppant therefore typically filters crude oil by allowing the delayed exposure of the particle to the crude oil in the fracture.

The filtered crude oil is typically extracted from the subsurface reservoir via the fracture, or fractures, in the subterranean formation through methods known in the art of oil extraction. The filtered crude oil is typically provided to oil refineries as feedstock, and the particle typically remains in the fracture.

Alternatively, in a fracture that is nearing its end-of-life, e.g. a fracture that contains crude oil that cannot be economically extracted by current oil extraction methods, the particle may also be used to extract natural gas as the fluid from the fracture. The particle, particularly where an active agent is utilized, digests hydrocarbons by contacting the reactive sites of the particle and/or of the active agent with the fluid to convert the hydrocarbons in the fluid into propane or methane. The propane or methane is then typically harvested from the fracture in the subsurface reservoir through methods known in the art of natural gas extraction.

The following examples are meant to illustrate the invention and are not to be viewed in any way as limiting to the scope of the invention.

### EXAMPLES

Examples 1-5 are proppants formed according to the subject invention comprising the hybrid coating disposed on the particle. Examples 1-5 are formed with the components disclosed in Table 1. The amounts in Table 1 are in grams, unless otherwise specified.

TABLE 1

| | Example | | | | |
|---|---|---|---|---|---|
| Component | Ex. 1 | Ex. 2 | Ex. 3 | Ex. 4 | Ex. 5 |
| Isocyanate Component A | 4.7 | — | — | — | — |
| Isocyanate Component B | — | 3.2 | 2.7 | — | — |
| Isocyanate Component C | — | — | — | 2.9 | 2.7 |
| Alkali Metal Silicate | 6.6 | — | — | — | — |
| Solution A | | | | | |
| Alkali Metal Silicate | — | 4.3 | — | 4.6 | — |
| Solution B | | | | | |
| Alkali Metal Silicate | — | — | 4.8 | — | 4.8 |
| Solution C | | | | | |
| Particle A | 300.0 | — | — | — | — |
| Particle B | — | 200.0 | 200.0 | 200.0 | 200.0 |
| Total Proppant | 311.3 | 207.5 | 207.5 | 207.5 | 207.5 |
| Percent by Weight | 3.8% | 3.8% | 3.8% | 3.8% | 3.8% |
| Hybrid Coating, Based | | | | | |
| on the Total Weight of | | | | | |
| the Particle | | | | | |
| Percent by Weight | 3.6% | 3.6% | 3.6% | 3.6% | 3.6% |
| Hybrid Coating Based | | | | | |
| on the Total Weight of | | | | | |
| the Proppant | | | | | |
| Percent by Weight | 96.4% | 96.4% | 96.4% | 96.4% | 96.4% |
| Particle, Based on | | | | | |
| the Total Weight of | | | | | |
| the Proppant | | | | | |

Isocyanate Component A is an isocyanate prepolymer formed by mixing about 80 parts by weight LUPRANATE ® M20 and about 20 parts by weight PLURACOL ® P2010, based on the total weight of all components used to form the isocyanate prepolymer. LUPRANATE ® M20 and PLURACOL ® P2010 are both commercially available from BASF Corporation of Florham Park, NJ.
Isocyanate Component B comprises 40 parts by weight LUPRANATE ® M and 60 parts by weight LUPRANATE ® M20, based on the total weight of the Isocyanate Component B. LUPRANATE ® M is commercially available from BASF Corporation of Florham Park, NJ.
Isocyanate Component C is LUPRANATE ® M20.
Alkali Metal Silicate Solution A is MEYCO ® MP 364 Part A, commercially available from BASF Corporation of Florham Park, NJ. Alkali Metal Silicate Solution A is a solution including sodium silicate, water, and other solvents and comprising of from about 15 to about 40 parts by weight sodium silicate based on 100 parts by weight Alkali Metal Silicate Solution A.
Alkali Metal Silicate Solution B comprises 86.5 parts by weight MEYCO ® MP 364 Part A and 13.5 parts by weight UNILINK ™ 4200, based on the total weight of the Alkali Metal Silicate Solution B. UNILINK ™ 4200 is commercially available from UOP of Des Plaines, IL.
Alkali Metal Silicate Solution C comprises 78.7 parts by weight MEYCO ® MP 364 Part A and 21.3 parts by weight UNILINK ™ 4200, based on the total weight of the Alkali Metal Silicate Solution C.
Particle A is Ottawa sand having a sieve size of 40/70, commercially available from U.S. Silica Company of Berkeley Springs, WV, which is pretreated with 400 ppm by weight SILQUEST ™ A1100, which is commercially available from Momentive Performance Materials of Albany, NY.
Particle B is Northern White sand having a sieve size of 40/70, which is commercially available from Preferred Sands of Radnor, PA.

Examples 6-9 are also proppants formed according to the subject invention comprising the hybrid coating disposed on the particle. Examples 6-9 are formed with components disclosed in Table 2. The amounts in Table 2 are in grams, unless otherwise specified.

TABLE 2

| | Example | | | |
|---|---|---|---|---|
| Component | Ex. 6 | Ex. 7 | Ex. 8 | Ex. 9 |
| Isocyanate Component D | 2.0 | — | — | — |
| Isocyanate Component E | — | 3.6 | 3.5 | 3.4 |
| Additive A | — | 3 drops, | 3 drops, | 3 drops, |
| | | (approx. | (approx. | (approx. |
| | | 0.15 g) | 0.15 g) | 0.15 g) |
| Alkali Metal Silicate Solution A | 1.8 | 3.4 | 3.5 | 3.6 |
| Particle B | 100.0 | 200.0 | 200.0 | 200.0 |
| Total Proppant | 103.8 | 207.0 | 207.0 | 207.0 |
| Percent by Weight Hybrid | 3.8% | 3.5% | 3.5% | 3.5% |
| Coating, | | | | |
| Based on the Total Weight of the | | | | |
| Particle | | | | |
| Percent by Weight Hybrid | 3.6% | 3.4% | 3.4% | 3.4% |
| Coating, | | | | |
| Based on the Total Weight | | | | |
| Proppant | | | | |
| Percent by Weight Particle, | 96.4% | 96.6% | 96.6% | 96.6% |
| Based on the Total Weight | | | | |
| Proppant | | | | |

Isocyanate Component D is a polycarbodiimide prepolymer formed by heating LUPRANATE ® L5120 to a temperature of about 150° C. for about 2 hours.
Isocyanate Component E is a polycarbodiimide prepolymer formed by heating a mixture comprising 59.8 parts by weight LUPRANATE ® M20, 39.87 parts by weight LUPRANATE ® M, 0.21 parts by weight 3-methyl-1-phenyl-2-phospholene oxide, 0.10 parts by weight triethyl amine, and 0.04 parts by weight ANTIFOAM A, based on 100 parts by weight of the mixture until the percent NCO by weight measures 18.6%.
ANTIFOAM A is an anti-foaming additive commercially available from Dow Corning Corporation of Midland, MI.
Additive A is MAFO ® CAB, a cocaminopropyl amino betain surfactant commercially available from BASF Corporation of Florham Park, NJ.
Isocyanate Component C is LUPRANATE ® M20.

### Example 1

To form Example 1 as is set forth in Table 1 above, the Isocyanate Component A and the Alkali Metal Silicate Solution A are mixed in a 400 mL beaker for 10 seconds with a 3.5 inch jiffy mixer blade at 400 RPM. After 10 seconds of mixing, the Particle A is added to the 400 mL beaker and mixed for 2 minutes to form the proppant of Example 1, which comprises particle A with the hybrid coating disposed thereon. Formation of Example 1 is complete after about 1 minute and 45 seconds of mixing, i.e., the proppant is free flowing and particulate in form. The proppant of Example 1 is formed at about 20° C.

Example 1 is tested for crush strength, the test results are set forth in Table 3 below. The appropriate formula for determining percent fines is set forth in API RP60. Prior to testing crush strength, Example 1 is sieved to ensure that a proppant sample comprises individual proppant particles which are greater than sieve size 35. The crush strength of Example 1 is tested by compressing a proppant sample (sieved to>sieve size 35) in a test cylinder (having a diameter of 1.5 inches as specified in API RP60) at 8000 psi. After compression, percent fines and agglomeration are determined

Agglomeration is an objective observation of a proppant sample, i.e., a particular Example, after crush strength testing as described above. The proppant sample is assigned a numerical ranking between 1 and 10. If the proppant sample agglomerates completely, it is ranked 10. If the proppant sample does not agglomerate, i.e., it falls out of the cylinder after crush test, it is rated 1.

TABLE 3

| | | | | | | | | Ag- |
|---|---|---|---|---|---|---|---|---|
| | Time | | Test | Test | Test | % | % | glom- |
| | after | | Weight | Temp. | Time | Fines | Fines | era- |
| Sample | Rxn. | | (g) | (° C.) | (min) | (<100) | (<70) | tion |
| Ex. 1a | 15 | min. | 23.78 | 21-24 | 2 | 4.6 | 12.4 | 6 |
| Ex. 1b | 60 | min. | 23.78 | 21-24 | 2 | 4.5 | 12.2 | 6 |
| Ex. 1c | 120 | min. | 23.78 | 21-24 | 2 | 3.2 | 10.7 | 6 |
| Ex. 1d | 1 | day | 23.78 | 21-24 | 2 | 2.0 | 5.0 | — |
| Ex. 1e | 1 day | | 22.59 | 21-24 | 2 | .7 | 3.9 | — |
| | (in h₂0) | | | | | | | |
| Ex. 1f | 1 day | | 23.78 | 21-24 | 2 | 2.0 | 5.0 | — |
| | (at 100° C.) | | | | | | | |
| Ex. 1g | 1 | day | 23.78 | 121 | 60 | 2.1 | 4.8 | 8 |

| | | | | | | | |
|---|---|---|---|---|---|---|---|
| Ex. 1h | 1 day | 23.78 | 121 | 60 | 1.9 | 4.4 | 5 |
| | (at 100° C.) | | | | | | |

The thermal properties of Example 1 are also tested via thermal gravimetric analysis (TGA) over a temperature range of 35 to 750° C. at a heating rate of 10° C./min using a TA Instruments Q5000 TGA. The results of the analysis are set forth in Table 4 below.

TABLE 4

| | Onset Temp. for | |
|---|---|---|
| | Thermal Degradation | Weight % |
| Sample | (° C.) | at 750° C. |
| Ex. 1i (Test 1) | 235 | 98.20 |
| Ex. 1j (Test 2) | 231 | 98.71 |

Referring now to Tables 3 and 4, Example 1 demonstrates excellent crush strength, agglomeration, and thermal stability. Notably, Example 1 has a coating weight of 3.8 percent by weight, based on the total weight of the particle, and still demonstrates excellent crush strength, agglomeration, and thermal stability.

### Examples 2-5

The isocyanate components and the alkali silicate solutions of Examples 2-5 allow for the formation of an isocyanate prepolymer in situ and the subsequent formation of the hybrid coating. To form Examples 2-5, as are set forth in Table 1 above, the Isocyanate Component B or C, depending on the particular example, and the Alkali Metal Silicate Solution B or C, again depending on the example, are mixed for 5 seconds in a 400 mL beaker with a 3.5 inch jiffy mixer blade at 480 PRM. After 5 seconds of mixing, the Particle B is added to the 400 mL beaker and mixed to form the proppant of Examples 2-5, which is free flowing and particulate in form and comprise particle B with the hybrid coating disposed thereon. The proppant of Examples 2-5 are formed at about 20° C.

Examples 2-5 are tested for crush strength, the test results are set forth in Table 5 below. The appropriate formula for determining percent fines is set forth in API RP60. Prior to testing crush strength, Examples 2-5 are sieved to ensure that a proppant sample comprises individual proppant particles which are greater than sieve size 35. The crush strength of Examples 2-5 are tested by compressing a proppant sample (sieved to >sieve size 35) in a test cylinder (having a diameter of 1.5 inches as specified in API RP60) at 10,000 psi. After compression, percent fines and agglomeration are determined.

TABLE 5

| | Test | Test | Test | % | % | |
|---|---|---|---|---|---|---|
| | Weight | Temp. | Time | Fines | Fines | Agglom- |
| Sample | (g) | (° C.) | (min) | (<100) | (<70) | eration |
| Ex. 2 | 23.78 | 21-24 | 2 | 5.7 | 10.2 | 4 |
| Ex. 3 | 23.78 | 21-24 | 2 | 5.2 | 9.4 | 4 |
| Ex. 4 | 23.78 | 21-24 | 2 | 4.7 | 9.0 | 2 |
| Ex. 5 | 23.78 | 21-24 | 2 | 6.6 | 11.7 | 1-2 |

The thermal properties of Examples 2-4 are also tested via thermal gravimetric analysis (TGA) over a temperature range of 35 to 750° C. at a heating rate of 10° C./min using a TA Instruments Q5000 TGA. The results of the analysis are set forth in Table 6 below.

TABLE 6

| | Onset Temp. for | |
|---|---|---|
| | Thermal Degradation | Weight % |
| Sample | (° C.) | at 750° C. |
| Ex. 2 (Test 1) | 242, 433 | 98.20 |
| Ex. 2 (Test 2) | 240, NA | 98.71 |
| Ex. 3 (Test 1) | 224, 407 | 98.22 |
| Ex. 3 (Test 2) | 227, 430 | 97.07 |
| Ex. 4 (Test 1) | 256, 406 | 98.29 |
| Ex. 4 (Test 2) | 256, 432 | 96.80 |

Advantageously, the isocyanate components and the alkali silicate solutions of Examples 2-5 allow for the formation of an isocyanate prepolymer in situ and the subsequent formation of the hybrid coating. Referring now to Tables 5 and 6, the proppants of Examples 2-5, having the hybrid coating disposed thereon, demonstrate excellent crush strength, agglomeration, and thermal stability. Notably, Examples 2-5 have a coating weight of 3.8 percent by weight, based on the total weight of the particle, and still demonstrate excellent crush strength, agglomeration, and thermal stability.

### Examples 6-9

To form Examples 6-9, as are set forth in Table 2 above, the Isocyanate Component D or E, depending on the particular example, and the Alkali Metal Silicate Solution A are mixed in a 400 mL beaker with a 3.5 inch jiffy mixer blade for 5 seconds at 480 PRM. After 5 seconds of mixing, the Particle B is added to the 400 mL beaker and mixed for 1 minute. After 1 minute of mixing, 3 drops of Additive A are added to the 400 mL beaker and mixed for 1 additional minute to form the proppant of Examples 6-9, which are free flowing and particulate in form. The proppants of Examples 6-9 are formed at about 20° C.

Examples 6-9 are tested for crush strength, the test results are set forth in Table 7 below. The appropriate formula for determining percent fines is set forth in API RP60. Prior to testing crush strength, Examples 6-9 are sieved to ensure that a proppant sample comprises individual proppant particles which are greater than sieve size 70. The crush strength of Examples 6-9 are tested by compressing a proppant sample (sieved to>sieve size 70) in a test cylinder (having a diameter of 1.5 inches as specified in API RP60) at 10,000 psi. After compression, percent fines and agglomeration are determined.

TABLE 7

| | Test | Test | Test | % | % |
|---|---|---|---|---|---|
| | Weight | Temp. | Time | Fines | Fines |
| Sample | (g) | (° C.) | (min) | (<100) | (<70) |
| Ex. 6 | 23.78 | 21-24 | 2 | 4.8 | 7.3 |
| Ex. 7 | 23.78 | 21-24 | 2 | 7.4 | 11.2 |
| Ex. 8 | 23.78 | 21-24 | 2 | 9.3 | 17.4 |
| Ex. 9 | 23.78 | 21-24 | 2 | 11.3 | 20.2 |

Advantageously, the isocyanate components, comprising carbodiimide prepolymers having isocyanate functionality, and the alkali silicate solutions of Examples 6-9 allow for the formation of the hybrid coating which is durable. Referring now to Table 7, the proppants of Examples 6-9 demonstrate excellent crush strength. Notably, the proppant of Example 6 has a coating weight of 3.8 percent by weight and the proppants of Examples 7, 8, and 9 have a coating weight of 3.5 percent by weight, based on the total weight of the particle and still demonstrate excellent crush strength.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present invention has been described in an illustrative manner, and it is to be understood that the terminology which has been used is intended to be in the nature of words of description rather than of limitation. Obviously, many modifications and variations of the present invention are possible in light of the above teachings. It is, therefore, to be understood that within the scope of the appended claims, the present invention may be practiced otherwise than as specifically described.

1. A proppant for hydraulically fracturing a subterranean formation, said proppant comprising:
A. a particle present in an amount of from about 90 to about 99.5 percent by weight based on the total weight of said proppant; and
B. a hybrid coating disposed about said particle and present in an amount of from about 0.5 to about 10 percent by weight based on the total weight of said proppant, said hybrid coating comprising the reaction product of:
(i) an isocyanate component; and
(ii) an alkali metal silicate solution comprising water and an alkali metal silicate.

2. A proppant as set forth in claim 1 wherein said isocyanate component comprises a polymeric isocyanate having an NCO content of about 31.5 weight percent.

3. A proppant as set forth in claim 1 wherein said isocyanate component comprises an isocyanate prepolymer which comprises the reaction product of an isocyanate and a polyol.

4. A proppant as set forth in claim 1 wherein said isocyanate component comprises a polycarbodiimide prepolymer having isocyanate functionality and an NCO content of from about 15 to about 50 weight percent.

5. A proppant as set forth in claim 4 wherein said polycarbodiimide prepolymer comprises the reaction product of an isocyanate reacted in the presence of a catalyst and wherein said isocyanate is further defined as a first isocyanate comprising polymeric diphenylmethane diisocyanate and having an NCO content of about 31.5 weight percent and a second isocyanate comprising 4,4′-diphenylmethane diisocyanate and having an NCO content of about 33.5 weight percent and said polycarbodiimide prepolymer comprises the reaction product of said first and second isocyanates.

6. A proppant as set forth in claim 4 wherein said polycarbodiimide prepolymer comprises the reaction product of a carbodiimide modified 4,4′-diphenylmethane diisocyanate heated to a reaction temperature of greater than about 150° C.

7. A proppant as set forth in claim 1 wherein said alkali metal silicate is sodium silicate and wherein said sodium silicate is present in an amount of from about 15 to about 40 percent by weight based on the total weight of said alkali metal silicate solution.

8. A proppant as set forth in claim 1 wherein said hybrid coating further comprises the reaction product of a polyol and/or an amine in addition to said isocyanate component and said alkali metal silicate solution.

9. A proppant as set forth in claim 1 wherein said particle is selected from the group of minerals, ceramics, sands, nut shells, gravels, mine tailings, coal ashes, rocks, smelter slag, diatomaceous earth, crushed charcoals, micas, sawdust, wood chips, resinous particles, polymeric particles, and combinations thereof.

10. A proppant as set forth in claim 1 wherein said particle is present in an amount of from about 94 to about 99 percent by weight based on the total weight of said proppant and said hybrid coating is present in an amount of from about 1 to about 6 percent by weight based on said total weight of said proppant.

11. A proppant as set forth in claim 1 that is thermally stable at temperatures greater than 200° C.

12. A proppant as set forth in claim 1 having a crush strength of 5% or less maximum fines less than sieve size 70 as measured by compressing a 23.78 g sample of said proppant in a test cylinder having a diameter of 1.5 inches for 1 hour at 10,000 psi and 121° C.

13. A method of forming a proppant for hydraulically fracturing a subterranean formation, wherein the proppant comprises a particle and a hybrid coating disposed about the particle, said method comprising the steps of:
A. providing the particle;
B. providing an isocyanate component;
C. providing an alkali metal silicate solution comprising water and an alkali metal silicate;
D. combining the isocyanate component and the alkali metal silicate solution to react and form the hybrid coating; and
E. coating the particle with the hybrid coating to form the proppant;
wherein the particle is present in an amount of from about 90 to about 99.5 percent by weight based on the total weight of the proppant and the hybrid coating is present in an amount of from about 0.5 to about 10 percent by weight based on the total weight of the proppant.

14. A method as set forth in claim 13 wherein the step of combining the isocyanate component and the alkali metal silicate solution to react and form the hybrid coating is conducted simultaneous with the step of coating the particle with the hybrid coating to form the proppant.

15. A method of hydraulically fracturing a subterranean formation which defines a subsurface reservoir with a mixture comprising a carrier fluid and a proppant comprising:
A. a particle present in an amount of from about 90 to about 99.5 percent by weight based on the total weight of the proppant; and
B. a hybrid coating disposed about the particle and present in an amount of from about 0.5 to about 10 percent by weight based on the total weight of the proppant, the hybrid coating comprising the reaction product of:
(i) an isocyanate component; and
(ii) an alkali metal silicate solution comprising water and sodium silicate;
said method comprising the step of pumping the mixture into the subsurface reservoir to fracture the subterranean formation.

16. A method as set forth in claim 15 further comprising the step of preparing the mixture comprising the carrier fluid and the proppant.

17. A method as set forth in claim 15 wherein the isocyanate component comprises a polymeric isocyanate having an NCO content of about 31.5 weight percent.

18. A method as set forth in claims 15 wherein the isocyanate component comprises an isocyanate prepolymer which comprises the reaction product of an isocyanate and a polyol.

19. A method as set forth in claim 15 wherein the isocyanate component comprises a polycarbodiimide prepolymer.

20. A method as set forth in claim 15 wherein the alkali metal silicate is sodium silicate.

21. A method as set forth in claim 15 wherein the particle is selected from the group of minerals, ceramics, sands, nut shells, gravels, mine tailings, coal ashes, rocks, smelter slag, diatomaceous earth, crushed charcoals, micas, sawdust, wood chips, resinous particles, polymeric particles, and combinations thereof.

22. A method as set forth in claim 13 wherein the steps of combining the isocyanate component and the alkali metal silicate solution to react and form the hybrid coating and coating the particle with the hybrid coating to form the proppant are conducted at a temperature of from about −10 to about 50° C.

23. A method as set forth in claim 13 wherein the steps of combining the isocyanate component and the alkali metal silicate solution to react and form the hybrid coating and coating the particle with the hybrid coating to form the proppant are collectively conducted in 10 minutes or less.
